(19) United States
(12) Patent Application Publication
(10) Pub. No.: US 2003/0053176 A1
(43) Pub. Date: Mar. 20, 2003

(54) Passive optical network system for effectively utilizing communication bandwidth

(76) Inventors: Yusuke Nishigaki, Kawasaki (JP); Masayuki Sato, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/053,405

(22) Filed: Jan. 16, 2002

(30) Foreign Application Priority Data
Sep. 19, 2001 (JP) 2001-284296

(51) Int. Cl. H04B 10/08; H04B 10/00

(52) U.S. Cl. 359/168; 359/110

(57) ABSTRACT

The present invention provides a passive optical network system having an optical line terminal for transmitting a plurality of types of distributed data using optical signals and a plurality of optical network terminations for receiving distributed data using optical signals. Each of the plurality of optical network terminations transmits a reception request for at least one of the plurality types of distributed data to said optical line terminal while designating the type. The optical line terminal transmits distributed data of the designated type among the plurality of types of distributed data to the plurality of optical network terminations.

### BACKGROUND OF THE INVENTION

1. Field of the Invention

The present invention relates to a passive optical network system and a communication method used in a passive optical network system. Furthermore, the present invention relates to an optical line terminal and optical network termination used in a passive optical network system.

2. Description of the Related Art

Passive optical networks (PON) are known as one type of communication system for performing broadcasting and multicasting of data. FIG. 13 is a block diagram showing the construction of a conventional PON system. This PON system has an optical line terminal (OLT) 101, three optical network terminations (ONT) 102a through 102c, a optical splitter 103, and a plurality of optical fiber links 104.

A service node 200 is connected to the OLT 101. This service node 200 is a node that provides data distribution services, and, for example, transmits distributed data of channels ch1 through chn with CATV numbers or the like to the OLT 101.

The distributed data of channels ch1 through chn transmitted to the OLT 101 from the service node 200 is accommodated in cells (hereafter referred to as “ATM cells”) according to the asynchronous transfer mode (ATM), and is transmitted to the ONTs 102a through 102c by means of light signals via the optical fiber links 104 and light splitter 103. Specifically, all of the distributed data of channels ch1 through chn is transmitted to the ONTs 102a through 102c via the optical fiber links 104.

User terminals such as television receivers, personal computers or the like, or other subordinate communication networks or the like (not shown in the figures), are connected to the ONTs 102a through 102c. Channel reception requests are sent to the ONTs 102a through 102b from these user terminals, other communication networks or the like. The ONTs 102a through 102c select only the ATM cells for which there has been a reception request among the channels ch1 through chn, and discard the remaining ATM cells. Then, the ONTs 102a through 102c transmit the selected ATM cells to the user terminals or the like.

For example, in a case where the ONT 102a has received a reception request for channels ch1 and ch3, the ONT 102a selects only the ATM cells accommodating the distributed data of channels ch1 and ch3 among the channels ch1 through chn, and transmits the distributed data accommodated in these ATM cells to the user terminals or the like.

Thus, in a conventional PON system, all of the distributed data of the channels ch1 through chn that is transmitted to the OLT 101 from the service node 200 is transmitted to the ONTs 102a through 102c via the optical fiber links 104 and light splitter 103.

Accordingly, even distributed data of channels not selected by any of the ONTs is transmitted to the ONTs 102a through 102c from the OLT 101 via the optical fibers links 104 and light splitter 103. As a result, the communication bandwidth of the optical fiber links is utilized in a wasteful manner.

### SUMMARY OF THE INVENTION

It is an object of the present invention to achieve effective utilization of the communication bandwidth in a PON network system.

A passive optical network system according to a first aspect of the present invention is a passive optical network system having an optical line terminal for transmitting a plurality of types of distributed data using optical signals, a plurality of optical network terminations for receiving said distributed data using optical signals; and a light splitting device for distributing the distributed data transmitted from said optical line terminal to said plurality of optical network terminations by means of optical signals, wherein each of said plurality of optical network terminations comprises: a control information transmitting unit for transmitting a reception request for at least one of said plurality of types of distributed data to said optical line terminal while designating the type of said at least one distributed data; and a data selection unit for selecting distributed data for said reception request from one or more types of distributed data transmitted from said optical line terminal; and wherein said optical line terminal comprises: a distributed data transmitting unit for transmitting distributed data that is set to be transmitted among said plurality of types of distributed data to said plurality of optical network terminations; and a setting unit for receiving said reception request and setting said distributed data transmitting unit so that distributed data of the types designated by said reception request is transmitted.

A communication method according to a first aspect of the present invention is a communication method in a passive optical network system having an optical line terminal for transmitting a plurality of types of distributed data using optical signals, a plurality of optical network terminations for receiving distributed data using optical signals, and a light splitting device for distributing the distributed data transmitted from said optical line terminal to said plurality of optical network terminations by means of optical signals, said method comprising steps of: transmitting, in each of said plurality of optical network terminations, a reception request for at least one of said plurality types of distributed data to said optical line terminal while designating the type of said at least one distributed data; and transmitting, in said optical line terminal, distributed data of the type designated by said reception request transmitted from each of said plurality of optical network terminations among said plurality of types of distributed data to said plurality of optical network terminations.

According to the first aspect of the present invention, the optical line terminal transmits distributed data whose reception is requested to the optical network terminations. Accordingly, distributed data whose reception is not requested is not transmitted from the optical line terminal to the optical network terminations. As a result, the communication bandwidth between the optical line terminal and the optical network terminations can be effectively utilized. Furthermore, since a large communication bandwidth can be allocated to the distributed data whose reception is requested, the communication speed of the distributed data whose reception is requested can be increased.

Preferably, said control information transmitting unit of said optical network termination transmits a reception ending request for requesting ending of the reception of distributed data that is being received, to said optical line terminal, said reception ending request designating the type of distributed data for which the ending of said reception is requested; and said setting unit of said optical line terminal receives said reception ending request, and cancels the setting of said distributed data transmitting unit for distributed data of the type designated by said reception ending request if distributed data of said designated type has not been selected by any optical network termination other than the optical network termination that has transmitted said reception ending request.

Thus, the communication bandwidth between the optical line terminal and the optical network terminations can be effectively utilized and the communication speed of the distributed data whose reception is requested can be increased.

An optical line terminal according to a second aspect of the present invention is an optical line terminal in a passive optical network system, for distributing distributed data to a plurality of optical network terminations by means of optical signals, comprising: a distributed data transmitting unit for transmitting distributed data that is set to be transmitted among a plurality of types of distributed data, to said plurality of optical network terminations; and a setting unit for receiving a reception request transmitted by at least one of said plurality of optical network terminations, said reception request designating the type of distributed data whose reception is requested among said plurality of types of distributed data, and for setting said distributed data transmitting unit so that distributed data of the types designated by said reception requests is transmitted.

The same actions and effects as in the case of the first aspect described above can also be obtained with the second aspect of the present invention.

An optical network termination according to a third aspect of the present invention is an optical network termination in a passive optical network, for receiving distributed data transmitted from an optical line terminal by means of optical signals, comprising: a control information transmitting unit for transmitting to said optical line terminal a reception request for setting said optical line terminal so that said optical line terminal selects and transmits distributed data whose reception is requested by said optical network termination among a plurality of types of distributed data, said reception request designating the type of said distributed data whose reception is requested; and a data selection unit for selecting and receiving distributed data for said reception request from one or more types of distributed data transmitted from said optical line terminal among said plurality of types of distributed data.

The same actions and effects as in the case of the first aspect described above can also be obtained with the third aspect of the present invention.

### BRIEF DESCRIPTION OF THE DRAWINGS

FIG. 1 is a block diagram illustrating the construction of a passive optical network (PON) system according to a first embodiment of the present invention;

FIG. 2 is a block diagram showing the detailed construction of the OLT;

FIG. 3 is a block diagram showing the detailed construction of the ONT;

FIG. 4 is a sequence diagram showing the flow of channel setting processing according to the first embodiment;

FIG. 5 shows one example of the channel setting table held by the channel setting device;

FIG. 6 is a sequence diagram showing the flow of channel setting cancellation processing in the first embodiment;

FIG. 7 is a sequence diagram showing the flow of channel setting processing in the second embodiment;

FIG. 8 shows one example of the channel selection table held by the channel setting device;

FIG. 9 shows one example of OLT channel selection information;

FIG. 10 is a sequence diagram showing the flow of the channel setting cancellation processing in the second embodiment;

FIG. 11 is a sequence diagram showing the flow of the channel setting processing in the third embodiment;

FIG. 12 is a sequence diagram showing the flow of the channel setting cancellation processing in the third embodiment; and

FIG. 13 is a block diagram showing the construction of a conventional PON system.

### DESCRIPTION OF THE PREFERRED EMBODIMENTS

First Embodiment

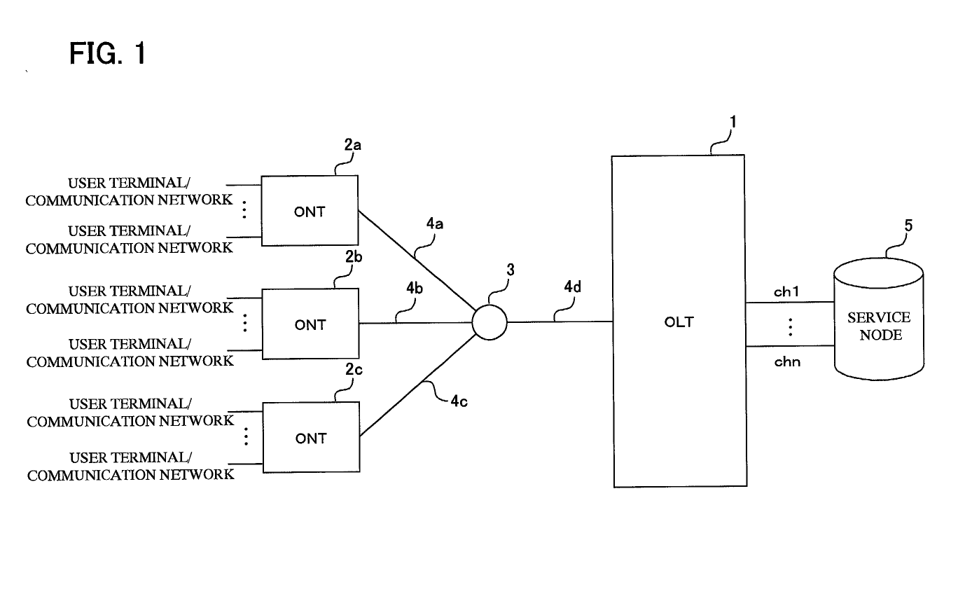

FIG. 1 is a block diagram illustrating the construction of a passive optical network (PON) system according to a first embodiment of the present invention. This PON system has an optical line terminal (OLT) 1, optical network terminations (ONT) 2a through 2c, a light splitter 3 and optical fiber links 4a through 4d.

The ONTs 2a through 2c are also called optical network units (ONUs). One or more user terminals (television receivers, computers or the like), other communication networks (e.g., intranets) or the like are connected to each of these ONTs 2a through 2c. Furthermore, in FIG. 1, three ONTs are shown as an example; however, some other number of ONTs (e.g., two or four or more ONTs) may also be connected.

A service node 5 is connected to the OLT 1. The service node 5 provides data distribution services to the user terminals, other communication networks or the like (hereafter, “user terminals, other communication networks or the like” will be referred to simply as “user terminals”) that are connected to the ONTs 2a through 2c. The distributed data provided by these data distribution services may include contents such as video data (e.g., cable television broadcasts), musical data or the like. In FIG. 1, only a single service node 5 is shown; however, a plurality of such service nodes may be present. For example, in the case of cable television, a number of service nodes corresponding to the number of cable television broadcast stations may be installed. In the present embodiment, n types (n is an integer equal to or greater than 2) of distributed data of channels ch1 through chn are supplied to the OLT 1 from the service node 5.

In the PON system shown in FIG. 1, the distributed data of channels requested by the ONTs 2a through 2c among the distributed data of the n channels supplied from the service node 5 is transmitted to the ONTs 2a through 2c from the OLT 1 via the optical fibers links 4a through 4d and light splitter 3. Then, the distributed data transmitted to the ONTs 2a through 2c is distributed to user terminals or the like from the ONTs 2a through 2c.

Details of the respective constituent elements of the PON system will be described below.

The OLT 1 selects channels requested by the ONTs 2a through 2c among the channels ch1 through chn transmitted from the service node 5, and outputs the distributed data of the selected channels to the optical fiber link 4d.

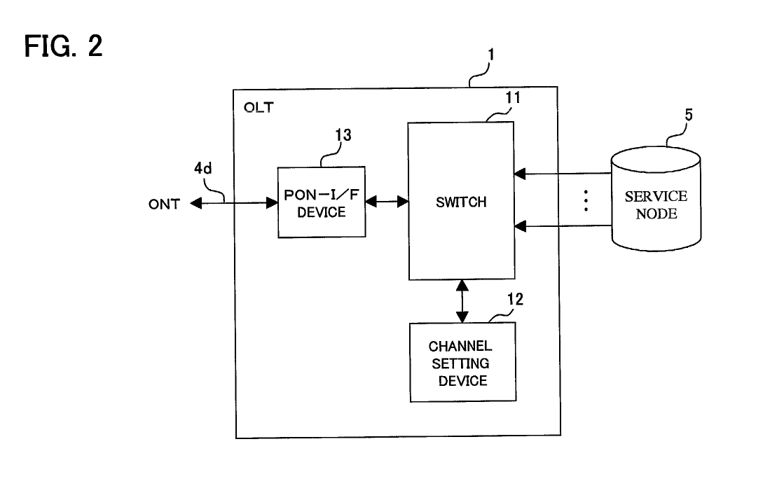

FIG. 2 is a block diagram showing the detailed construction of the OLT 1. The OLT 1 has a switch 11, a channel setting device 12, and a PON interface device (hereafter referred to as a “PON-IF device”) 13.

The switch 11 is connected to the service node 5, the channel setting device 12 and the PON-IF device 13. One terminal of the PON-IF device 13 is connected to the switch 11, while the other terminal is connected to the optical fiber link 4d. The transmission and reception of data between the switch 11 and the PON-IF device 13, and between the switch 11 and the channel setting device 12, are performed by means of electrical signals.

The switch 11 accommodates the distributed data of the channels designated by the channel setting device 12 (among the distributed data of the channels ch1 through chn provided by the service node 5) in ATM cells, and outputs these ATM cells to the PON-IF device 13. Furthermore, on the basis of information (e.g., virtual channel identifiers) in the header parts of the ATM cells, the switch 11 sends the data (channel setting requests and the like, described later) of the ATM cells transmitted from the ONTs 2a through 2c via the PON-IF device 13 to the channel setting device 12, or transmits this data to the ONTs 2a through 2c via the PON-IF device 13.

On the basis of channel setting requests (described later) and channel setting cancellation requests (described later) which constitute control information sent from the ONTs 2a through 2c, the channel setting device performs setting and setting cancellation of the switch 11 so that the distributed data of requested channels (among the distributed data of the channels ch1 through chn) is sent to the PON-IF device 13.

The PON-IF device 13 accomplishes the interchange between electrical signals transmitted and received between the PON-IF device 13 and the switch 11, and optical signals transmitted and received between the PON-IF device 13 and the optical fiber links 4d (as well as the ONTs 2a and 2d).

Furthermore, the PON-IF device 13 also has a frame terminating function; with this function, the PON-IF device 13 accommodates ATM cells sent from the switch 11 in specified frames and transmits these frames on the one hand, while on the other hand the PON-IF device 13 breaks down the frames that are input from the optical fiber link 4d into ATM cells, and outputs the ATM cells contained in the frames to the switch 11. For example, 155.52 Mbps frames according to STM-1 (synchronous transport module level 1) are used as these specified frames.

Furthermore, the optical fiber link 4d comprises a single optical fiber link; if transmitted signals and received signals are transmitted and received respectively by light of different wavelengths within a single optical fiber, the PON-IF device 13 also has a light wavelength separating function which removes the reflected waves of transmitted signals or the like from the light that is received, and extracts only the received signals.

Returning to FIG. 1, the light splitter 3 distributes (multicasts or broadcasts) optical signals transmitted from the OLT 1 via the optical fiber link 4d to the optical fiber links 4a through 4c, and collects optical signals respectively transmitted from the ONTs 2a through 2c via the optical fibers links 4a through 4c in the optical fiber link 4d.

In the case of the optical fiber links 4a through 4d, the optical fibers links directed from the OLT 1 toward the ONTs 2a through 2c (downstream) and the optical fiber links directed from the ONTs 2a through 2c toward the OLT 1 (upstream) may be constructed from the same optical fibers (single optical fibers), or the downstream and upstream optical fiber links may be constructed from different optical fibers (two optical fibers).

Similarly, the light splitter 3 may also be constructed from two light splitters, i.e., different optical fibers for downstream use and upstream use, or both the downstream and upstream light splitters may be constructed from the same single optical fiber. Moreover, a plurality of such light splitters 3 may be installed in a tree configuration.

The ONTs 2a through 2c are respectively connected to the optical fiber links 4a through 4c at one end; the other ends of the ONTs 2a through 2c are connected to one or more user terminals.

The ONTs 2a through 2c select only distributed data of channels requested by user terminals connected to the respective ONTs among the distributed data transmitted from the OLT 1, and output the distributed data of the selected channels to these user terminals connected to the respective ONTs. Furthermore, the ONTs 2a through 2c transmit data (channel setting requests and the like) from the user terminals to the OLT 1.

The ONTs 2a through 2c all have the same construction; below, the details of the ONTs will be described using the ONT 2a as a representative example.

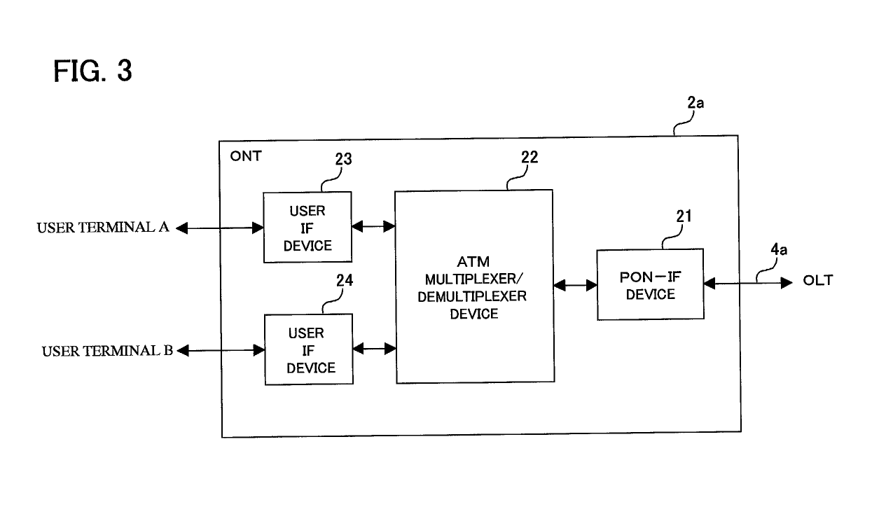

FIG. 3 is a block diagram showing the detailed construction of the ONT 2a. The ONT 2a has a PON interface device (PON-IF device) 21, an ATM multiplexer/demultiplexer device 22, and two user interface units (hereafter referred to as “user IF devices”) 23 and 24. In FIG. 2, only two user IF devices are shown as an example; however, a number of user IF devices equal to the number of user terminals connected to the ONT 2a (i.e., a single user IF device or two or more IF devices) may be installed.

One end of the PON-IF device 21 is connected to the optical fiber link 4a, while the other end is connected to the ATM multiplexer/demultiplexer device 22. One end of the user IF device 23 is connected to the ATM multiplexer/demultiplexer device 22, while the other end of the user IF device 23 is connected to a user terminal (“user terminal A”). One end of the user IF device 24 is connected to the ATM multiplexer/demultiplexer device 22, while the other end of the user IF device 24 is connected to a user terminal (“user terminal B”).

The PON-IF device 21 has the same function as the PON-IF device 13 of the OLT 1 shown in FIG. 2. Specifically, this PON-IF device 21 converts the frames of optical signals from the optical fiber link 4a into ATM cells of electrical signals, and sends these electrical signals to the ATM multiplexer/demultiplexer device 22; furthermore, the PON-IF device 21 also accommodates the ATM cells of electrical signals sent from the ATM multiplexer/demultiplexer device 22 in frames, and transmits these frames as optical signals to the optical fiber link 4a (OLT 1).

The ATM multiplexer/demultiplexer device 22 demultiplexes the ATM cells sent from the PON-IF device 21 (i.e., splits the signals into ATM cell units), and selects only the ATM cells accommodating the distributed data of channels requested by the user terminals A and B.

For example, in a case where the distributed data of four channels chi, chj, chk and chm (i, j, k and m are values of 1 to n) is transmitted from the OLT 1 to the ATM multiplexer/demultiplexer device 22 via the PON-IF device 21, and the channel chi is requested by the user terminal A while the channel chk is requested by the user terminal B, the ATM multiplexer/demultiplexer device 22 selects only the ATM cells accommodating the distributed data of the channels chi and chk, and discards the ATM cells of the remaining channels.

Then, the ATM multiplexer/demultiplexer device 22 distributes the selected ATM cells between the user IF devices 23 and 24. In the abovementioned example, the ATM cells of the channel chi are sent to the user IF device 23 that is connected to the user terminal A, and the ATM cells of the channel chk are sent to the user IF device 24 that is connected to the user terminal B.

Of course, in a case where the terminals A and B both request the same channel chi, the ATM multiplexer/demultiplexer device 22 selects only the ATM cells of the channel chi, and sends the ATM cells of the same channel chi to both user IF devices 23 and 24. Furthermore, if one user terminal requests a plurality of channels, the ATM cells of this plurality of channels are sent to one user IF device 23 or 24 from the ATM multiplexer/demultiplexer device 22.

Furthermore, the ATM multiplexer/demultiplexer device 22 multiplexes data (channel setting requests and the like) sent by means of ATM cells from the user IF devices 23 and 24, and sends this data to the PON-IF device 21.

In order to perform this processing, the ATM multiplexer/demultiplexer device 22 has a multiplexer unit which multiplexes ATM cells sent from the user IF devices 23 and 24, and outputs these ATM cells to the PON-IF device 21, a demultiplexer unit which demultiplexes the ATM cells sent from the PON-IF device 21 (i. e., splits the data into ATM cell units), selects only the ATM cells accommodating distributed data of the channels requested by the user terminals A and B, and outputs these ATM cells to the user IF device 23 or 24, and a control unit which controls the multiplexer unit and demultiplexer unit.

It is desirable that the multiplexer unit and demultiplexer unit be constructed from hardware circuits in order to perform high-speed processing. The control unit may be constructed from a CPU or microcomputer, and a program that is executed by this CPU or microcomputer, or may be constructed from a hardware circuit. Furthermore, the control unit has a memory device (semiconductor memory, hard disk or the like) which stores data, programs and the like that are required for processing.

The user IF devices 23 and 24 perform an interchange between ATM cells that are transmitted and received between the user IF devices 23, 24 and the ATM multiplexer/demultiplexer device 22, and the data format that is transmitted and received between the user IF devices 23 and 24 and the user terminals A and B. If the user terminals A and B are terminals that transmit and receive ATM cells, then the user IF devices input and output ATM cells “as is” between the user IF devices 23 and 24 and the user terminals A and B. Furthermore, if the user terminal A or B is a terminal that transmits and receives (for example) IP packets, then the user IF devices have a function that converts ATM cells into IP packets.

Next, the channel setting processing and channel setting cancellation processing in a PON system that has such a construction will be described.

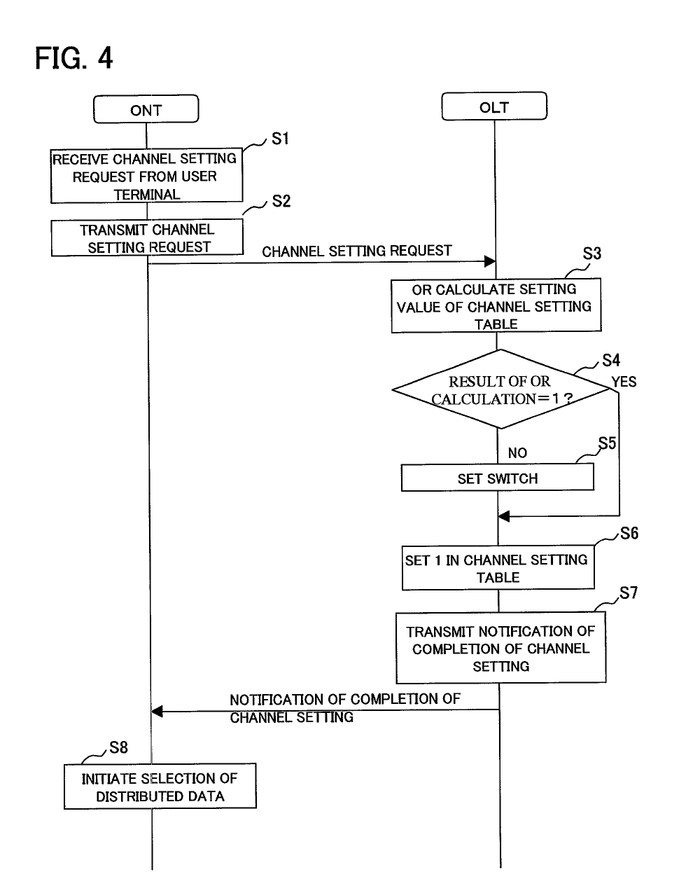

FIG. 4 is a sequence diagram showing the flow of channel setting processing according to the first embodiment. The ONT 2a shown in FIG. 3 will be described as an example.

When the user of the user terminal A or B (hereafter, “A or B” will be indicated as “A (B)”) requests the reception of a channel (designated as “channel chx”) among the channels ch1 through chn, the user terminal A (B) transmits this reception request to the ONT 2a as a channel setting request. This channel setting request contains information indicating the channel for which reception is requests (e.g., a channel number or the like, hereafter referred to as “channel identifying information”).

When the user IF device 23 or 24 (hereafter, “23 or 24” is indicated as “23 (24)”) of the ONT 2a receives a channel setting request from the user terminal A (B) (step S1), the user IF device 23 (24) outputs this channel setting request to the ATM multiplexer/demultiplexer device 22 by means of an ATM cell. The virtual channel identifier (VCI) in the header part of this ATM cell contains a prescribed identifier in order to transmit this ATM cell to the channel setting device 12 of the OLT 1. Furthermore, a channel setting request including channel identifying information is accommodated in the payload part of this ATM cell.

This ATM cell is transmitted from the ATM multiplexer/demultiplexer device 22 to the OLT 1 via the PON-IF device 21 (step S2).

The ATM cell accommodating the channel setting request is sent to the channel setting device 12 via the PON-IF device 13 and switch 11 of the OLT 1 in accordance with the VCI in the header part of this ATM cell.

When the channel setting device 12 receives the channel setting request, the channel setting device 12 initiates the setting of the channel chx indicated by the channel identifying information contained in this channel setting request. Specifically, the channel setting device 12 first performs a logical sum calculation (OR calculation) of the setting values of the channel chx in the channel setting table held by the channel setting device 12 (step S3).

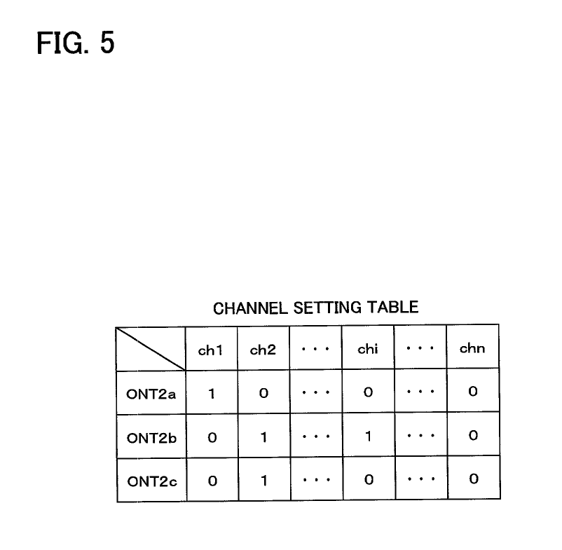

FIG. 5 shows one example of the channel setting table held by the channel setting device 12. The channel setting table indicates which channels are currently selected by the ONTs 2a through 2c and supplied to the user terminals.

A column showing the ONTs in the PON system is entered in the vertical direction of this table, and columns indicating which ONT has selected which of the channels ch1 through chn are lined up in the horizontal direction of this table. A logical value of “1” is set in the table cell for each channel selected by one of the ONTs, and a logical value of “0” is set in the table cells of channels that are not: selected. In the example shown in FIG. 5, the ONT 2a has selected at least the channel ch1, the ONT 2b has selected at least the channels ch2 and chi, and the ONT 2c has selected at least the channel ch2.

The distributed data of the channels selected by at least one of the ONTs 2a through 2c is transmitted not only to the ONTs that have selected this channel, but also to the other ONTs as well. The reason for this is that the light splitter 3 distributes (copies) the optical signals from the OLT 1 to the three optical fiber links 4a through 4c. For example, even in a case where the distributed data of the channel ch1 has been selected only by the ONT 2a, this distributed data is also distributed to the ONTs 2b and 2c by the light splitter 3.

The logical sum calculation is accomplished by determining the logical sum of all of the logical values of the channel chx in the channel setting table. For example, in a case where the channel chx is the channel ch1, the logical sum of the three logical values “1”, “0” and “0” in the table cells of ch1 in the channel setting table is determined, and the result of the calculation is 1+0 +0=1. On the other hand, in a case where the channel chx is the channel ch2, the result of the calculation is 0+1+1=1. The result of the calculation of the logical sum for the channel chn is 0.

Since channels for which the result of the logical sum calculation is 1 are channels that have already been selected by at least one ONT, the distributed data of these channels has already been transmitted to all of the ONTs. On the other hand, since channels for which the result of the logical sum calculation is 0 are channels that have not been selected by any of the ONTs, the distributed data of these channels is not transmitted to the ONTs from the OLT 1.

Returning to FIG. 4, in a case where the result of the logical sum calculation for a channel chx for which there has been a channel setting request is 0 (NO in step S4), the channel chx refers to a channel that has not been transmitted to any of the ONTs 2a through 2c. Accordingly, in this case, the channel setting device 12 sets the switch 11 so that the distributed data of the channel chx is distributed to the ONTs 2a through 2c (step S5). As a result, the distributed data of the channel chx is distributed to the ONTs 2a through 2c from the service node 5 via the switch 11, PON-IF device 13, optical fiber link 4d, light splitter 3 and optical fiber links 4a through 4d.

After setting the switch 11, the channel setting device 12 sets the logical value of “1” in the table cell of the channel chx of the ONT 2a in the channel setting table in order to indicate that the channel chx has been selected by the ONT 2a (step S6). This set logical value is used in the subsequent logical value sum calculation. Furthermore, the processing of this step S6 may be performed prior to step S5.

Next, the channel setting device 12 transmits a notification of the completion of channel setting to the ONT 2a (as well as 2b and 2c) via the switch 11 and PON-IF device (step S7). This notification is also accommodated in an ATM cell. A specified identifier indicating that this ATM cell is addressed to the ONT 2a (ATM multiplexer/demultiplexer device 22 (control unit)) is used as the VCI in the header part of this ATM cell. Furthermore, a notification of the completion of channel setting is accommodated in the payload part of this ATM cell. Channel identifying information for the channel whose setting has been completed may also be included in this notification.

The ATM multiplexer/demultiplexer device 22 receives the transmitted notification of the completion of channel setting via the PON-IF device 21 of the ONT 2a.

The ATM multiplexer/demultiplexer device 22 (control unit) of the ONT 2a identifies ATM cells containing a notification of the completion of channel setting by means of the VCI in the header parts of the ATM cells. Then, as a result of receiving a notification of the completion of channel setting, the ATM multiplexer/demultiplexer device 22 sets itself so that the channel chx is selected. As a result, the selection (reception) of the distributed data of the channel chx is initiated (step S8). The distributed data of the selected channel chx is transmitted to the user terminal A (B) via the user IF device 23 (24).

On the other hand, if the result of the logical sum calculation is 1 in step S4 (YES in step S4), this means that the distributed data of the channel chx has already been transmitted to the ONTs 2a through 2c from the OLT 1. In other words, the switch 11 is set so that the distributed data of the channel chx is transmitted to the ONTs 2a through 2c. Accordingly, in this case, the channel setting device 12 does not set the switch 11, and the processing of the steps S6 and S7 is performed.

Meanwhile, if the selection of the distributed data of selected channels is stopped, the following channel setting cancellation processing is performed.

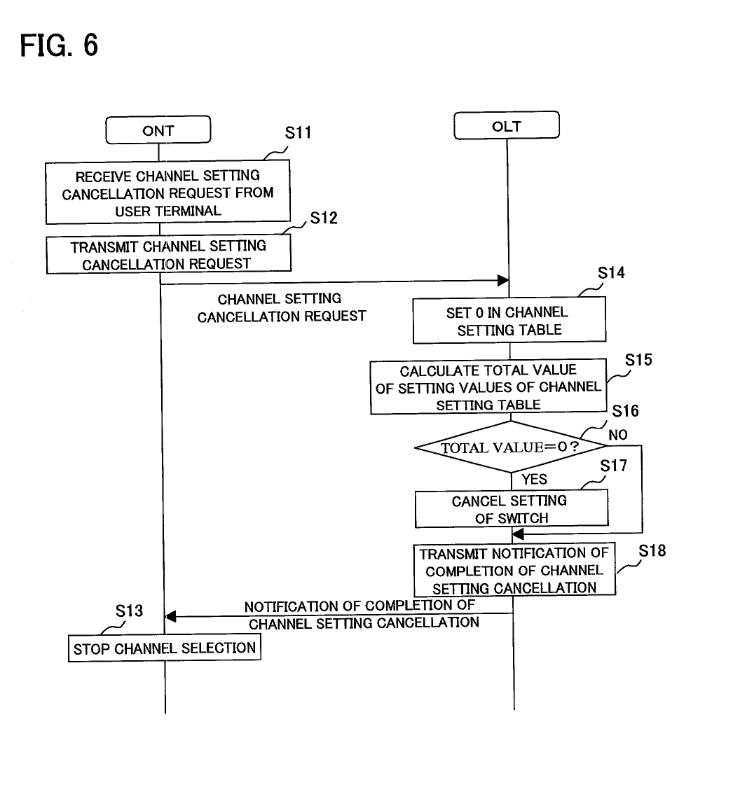

FIG. 6 is a sequence diagram showing the flow of channel setting cancellation processing in the first embodiment. As in the case of channel setting process (FIG. 4), this description will use the ONT 2a as an example.

When the ONT 2a receives a request to end the reception of the distributed data of the channel chx that is currently being received (i.e., a request for channel setting cancellation) (step S11), the user IF device 23 (24) accommodates this channel setting cancellation request in the payload part of an ATM cell, and sends this ATM cell to the ATM multiplexer/demultiplexer device 22. The ATM multiplexer/demultiplexer device 22 transmits this ATM cell to the OLT 1 via the PON-IF device 21 (step S12). Channel identifying information that identifies the channel for which cancellation is requested is included in this channel setting cancellation request.

The ATM cell in which the channel setting cancellation request is accommodated is sent to the channel setting device 12 via the PON-IF device 13 and switch 11 of the OLT 1 in accordance with a specified VCI. The channel setting device 12 sets the logical value of the channel setting table (see FIG. 5) at “0” for the channel chx indicated by the channel identifying information contained in the channel setting cancellation request.

Next, the channel setting device 12, dealing with the logical values of the channel setting table as integers, adds the setting values of the channel chx, and determines the total value of these setting values (step S15). For instance, in the example shown in FIG. 5, the total value for the channel ch1 is 1, and the total value for the channel ch2 is 2.

Next, the channel setting device 12 judges whether or not the total value is 0 (step S16). Channels for which the total value is 0 are channels that have not been selected by any ONT. Channels for which the total value is a value other than 0 are channels that have been selected by at least one ONT. Accordingly, by judging whether or not the total value is 0, it is possible to judge whether or not channel setting cancellation can be performed.

In a case where the total value for the channel chx is 0 (YES in step S16), none of the ONTs has selected the channel chx,, and the channel setting device 12 cancels the setting of the channel chx by the switch 11 (step S17). As a result, the distributed data of the channel chx is not output to the PON-IF device 13 from the switch 11; consequently, this data is not transmitted to the ONTs 2a through 2c.

Thus, the distributed data of channels that have not been requested by any of the ONTs is not transmitted to the ONTs from the OLT. As a result, the communication band between the OLT 1 and the ONTs 2a through 2c can be effectively utilized.

On the other hand, in a case where the total value is not 0 in step S16 (NO in step S16), this means that the channel chx has been selected by other ONTs. Accordingly, in this case, the channel setting device 12 maintains the setting of the switch 11.

Following the processing in step S17, or in the case of a NO in step S16, the channel setting device 12 transmits a notification of the completion of channel setting cancellation to the ONT 2a (step S18).

After receiving a notification of the completion of channel setting cancellation, the ATM multiplexer/demultiplexer device 22 (control unit) of the ONT 2a stops the selection of the channel chx (step S13). Furthermore, the processing of this step S13 may be performed following the transmission of the request for channel setting cancellation (step S12) and prior to the reception of the notification of completion of channel setting cancellation.

Furthermore, the channel setting processing and channel setting cancellation processing of the first embodiment was described using the ONT 2a as an example; however, the same processing is also performed by the ONTs 2b and 2c.

Thus, in the present embodiment, not all of the distributed data of the channels ch1 through chn is transmitted from the OLT 1 to the ONTs 2a through 2c; instead, only the distributed data of channels for which there has been a channel setting request (i.e., a reception request) is transmitted. Furthermore, the transmission of the distributed data of channels for which there has been a channel setting cancellation request is stopped. Accordingly, the communication band between the OLT 1 and ONTs 2a through 2c can be effectively utilized; furthermore, since a large communication band can be allocated to the required distributed data, the required distributed data can be transmitted at a high speed.

Second Embodiment

The OLT 1 can also provide information that indicates the channel selection status to the ONTs 2a through 2c.

The overall construction of the PON system of the second embodiment is that same as that shown in FIG. 1; accordingly, a description is omitted here. Furthermore, the construction of the OLT 1 is also the same as that shown in FIG. 2, and the construction of the ONTs 2a through 2C is the same as that shown in FIG. 3; accordingly, a description of these parts is omitted here.

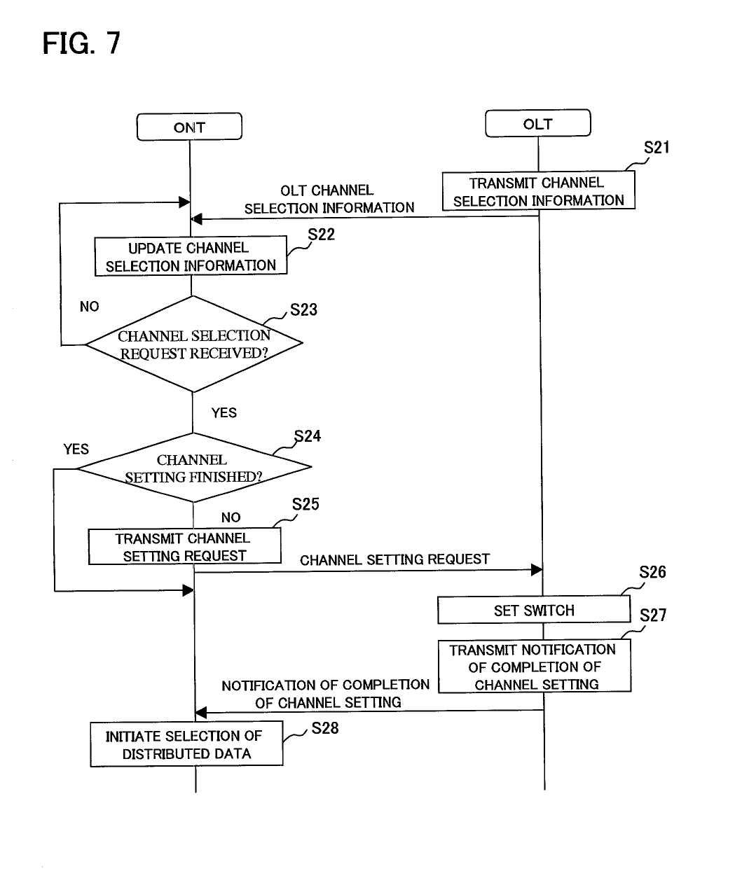

FIG. 7 is a sequence diagram showing the flow of channel setting processing in the second embodiment. The following description will use the ONT 2a shown in FIGS. 1 and 3 as an example.

In the present embodiment, the channel setting device 12 of the OLT 1 holds a channel selection table, and periodically (e.g., at intervals of several milliseconds, intervals of several seconds or the like) transmits information that indicates the channel selection status (hereafter referred to as “OLT channel selection information”) to the ONTs 2a through 2c. (step S21).

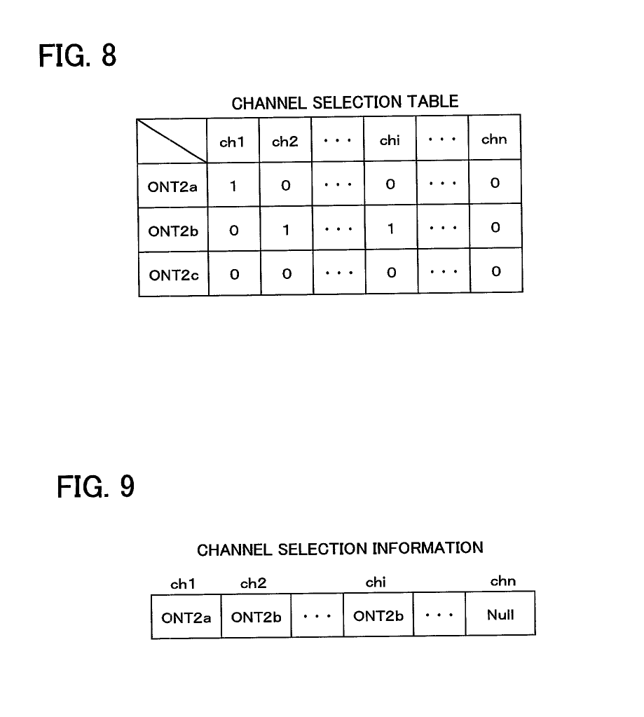

FIG. 8 shows one example of the channel selection table held by the channel setting device 12. The channel selection table indicates the ONT that initially selects each channel in a state in which the respective channels ch1 through chn have not been previously selected by any of the ONTs (this includes a state wherein even if a channel has once been selected by ONTs, this channel selection has subsequently been canceled from all of the ONTs).

In the channel selection table, the ONTs corresponding to the table cells in which a logical value of “1” is set are the ONTs that have initially selected the channels corresponding to these table cells. In the case of channels for which a logical value of “1” has been set, the ONTs corresponding to table cells in which a logical value of “0” has been set are in some cases ONTs that have selected the channels corresponding to these table cells, and in some cases ONTs that have not selected these channels. Channels for which all of the logical values are “0” are channels that have not been selected by any of the ONTs.

The example of a table shown in FIG. 8 indicates that the ONT 2a has initially selected the channel ch1 in a state in which the channel ch1 was not previously selected by any of the ONTs. Similarly, this table indicates that the channels ch2 and chi have been initially selected by the ONT 2b. Furthermore, the table indicates that the channel chn has not been selected by any of the ONTs.

FIG. 9 shows one example of OLT channel selection information. The OLT channel selection information is an arrangement of identifying information for ONTs that have initially selected the respective channels ch1 through chn. This OLT channel selection information is prepared by extracting ONTs for which a logical value of “1” is set in the channel selection table. However, a value which cannot be taken as ONT identifying information (e.g., a null value) is accommodated in the table cells of channels that have not been selected by any of the ONTs (the table cell for channel chn in FIG. 9).

This OLT channel selection information is accommodated in the payload part of an ATM cell, and is transmitted to the ONTs 2a through 2c. A specified identifier which causes this ATM cell to be received by the respective ATM multiplexer/demultiplexer devices 22 of the ONTs 2a through 2c is used as the VCI in the header part of this ATM cell.

Returning to FIG. 7, the ATM multiplexer/demultiplexer device 22 (control unit) of the ONT 2a stores the OLT channel selection information transmitted from the OLT 1 in an internal memory device (semiconductor memory, hard disk or the like), and each time that new OLT channel selection information is transmitted, the ATM multiplexer/demultiplexer device 22 updates the previously stored OLT channel selection information using the new channel selection information (step S22).

Next, the ATM multiplexer/demultiplexer device 22 of the ONT 2a judges whether or not a channel setting request has been received from the user IF device 23 (24) (step S23). As in the first embodiment, this channel setting request contains channel identifying information. If the ATM multiplexer/demultiplexer device 22 has not received a channel setting request from the user IF device 23 (24) (NO in step S23), the processing returns to step S22, and updating processing of the OLT channel selection information is performed when new OLT channel selection information is received.

On the other hand, if the ATM multiplexer/demultiplexer device 22 has received a channel setting request from the user IF device 23 (24) (YES in step S23), a judgement is made as to whether or not the channel indicated by the received channel setting request (designated as the channel chx) has been selected (set) by one of the ONTs (step S24). This judgement is accomplished by checking whether or not the table cell for the channel chx in the OLT channel selection information has a value other than a null value.

In cases where the channel chx has been selected by one of the ONTs (i.e., in cases where the table cell for the channel chx has a value other than a null value) (YES in step S24), this means that the distributed data of the channel chx has already been transmitted from the OLT 1 to the ONTs 2a through 2c. Accordingly, in this case, the ATM multiplexer/demultiplexer device 22 sets itself so that the channel chx is selected, without transmitting a channel setting request to the OLT 1. As a result, the ATM multiplexer/demultiplexer device 22 initiates the selection of the distributed data of the channel chx (step S28).

Afterward, the ATM multiplexer/demultiplexer device 22 sends the distributed data of the channel chx to the user IF device 23 (24) that transmitted the channel setting request, and this distributed data is transmitted to the user terminal A (B).

By the way, for example, in a case where a channel setting request for the channel chx is sent from the user terminal B to the ONT 2a in a state in which a channel setting request for the channel chx has been sent from the user terminal A to the ONT 2a, and the ONT 2a (ATM multiplexer/demultiplexer device 22) has already selected the channel chx, the ATM multiplexer/demultiplexer device 22 of the ONT 2a transmits the distributed data of the channel chx that has already been selected to the user terminal B in addition to the user terminal A, without transmitting a channel setting request to the OLT 1.

On the other hand, in a case where the channel chx has not been selected by any of the ONTs (i.e., in a case where the table cell for the channel chx has a null value) (NO in step S24), the ATM multiplexer/demultiplexer device 22 transmits a setting request for the channel chx to the OLT 1 as in the first embodiment (step S25).

In the same manner as in the processing of step S5 in the first embodiment, the channel setting device 12 of the OLT 1 sets the switch 11 (step S26). Then, as in the processing of step S7 in the first embodiment, the channel setting device 12 transmits a notification of the completion of channel setting to the ONT 2a (step S27). Furthermore, the channel setting device 12 does not update the channel selection table (see FIG. 8).

After receiving the notification of the completion of channel setting, the ATM multiplexer/demultiplexer device 22 (control unit) of the ONT 2a sets itself so that the distributed data of the channel chx is selected, and initiates the selection of the distributed data of the channel chx (step S28). The processing of step S28 may be performed following the processing of step S25 and prior to the processing of step S27.

Thus, in the second embodiment, the ONT 2a (2b, 2c) judges whether or not a channel setting request is to be transmitted, and transmits a channel setting request to the OLT 1 only when channel setting is necessary. Accordingly, there is no need for the OLT 1 to judge whether or not channel setting such as a logical sum calculation or the like is necessary, so that the processing burden on the OLT 1 is lightened.

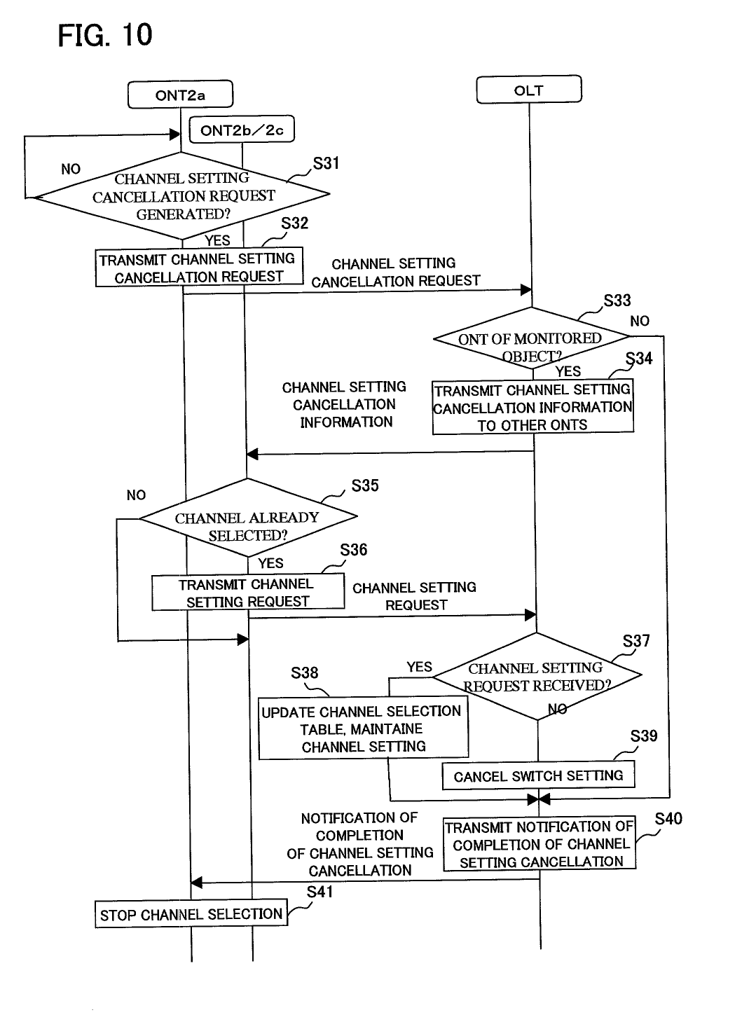

FIG. 10 is a sequence diagram showing the flow of the channel setting cancellation processing in the second embodiment.

When the ATM multiplexer/demultiplexer device 22 of the ONT 2a receives a channel setting cancellation request for the previously selected channel chx from the user terminal A (B) (YES in step S31), the ATM multiplexer/demultiplexer device 22 transmits a channel setting cancellation request to the OLT 1 (step S32). This channel setting cancellation request is the same as that in the first embodiment.

When the channel setting device 12 of the OLT 1 receives a channel setting cancellation request for the channel chx, the ONT 2a that has transmitted the channel setting cancellation request judges whether or not the ONT 2a is an ONT that is the object of monitoring (an ONT of the monitored object) with respect to the channel chx (step S33). The term “ONT that is the object of monitoring with respect to the channel chx” refers to an ONT for which a logical value of “1” has been set in the table cell for the channel chx in the channel selection table (see FIG. 8). For example, in a case where the channel chx is the channel ch1 in the channel selection table, the ONT 2a is an ONT that is the object of monitoring with respect to the channel ch1.

In a case where the ONT 2a is an ONT that is the object of monitoring with respect to the channel chx (YES in step S34), the channel setting device 12 transmits channel setting cancellation information indicating cancellation of the setting of the channel chx to the ONTs (here, the ONTs 2b and 2c) other than the ONT 2a that transmitted the channel setting cancellation request (step S34). Furthermore, this channel setting cancellation information is also transmitted to the ONT 2a by the light splitter 3; however, the ONT 2a discards this information instead of selecting the information. Channel identifying information (a channel number or the like) which identifies the channel for which the channel setting is to be cancelled is included in this channel setting cancellation information. Furthermore, specified identifying information which is used to ensure reception by the respective multiplexer/demultiplexer devices of the ONTs 2b and 2c is contained in the header part of the ATM cell that accommodates this information.

When the respective ATM multiplexer/demultiplexer devices 22 of the ONTs other than the ONT 2a, i.e., the ONTs 2b and 2c, receive the channel setting cancellation information, these ONTs 2b and 2c make a judgement as to whether or not the channel chx indicated by the channel identifying information contained in the channel setting cancellation information has been selected (step S35).

In a case where the ATM multiplexer/demultiplexer device 22 of the ONT 2b or 2c itself has selected the channel chx (YES in step S35), a channel setting request (including channel identifying information) is transmitted to the OLT 1 within a fixed time T1 (e.g., several milliseconds or several tens of milliseconds) following the reception of the channel setting cancellation information (step S36).

On the other hand, in a case where the multiplexer/demultiplexer device 22 of the ONT 2b or 2c has not selected the channel chx (NO in step S35), the ATM multiplexer/demultiplexer device 22 of the ONT 2b or 2c does not transmit a channel setting request. As a result of ONTs that are the object of monitoring thus being set in advance, the OLT 1 need not always transmit channel setting cancellation information when a channel setting cancellation request is received.

When the channel setting device 12 of the OLT 1 receives a channel setting request for the channel chx designated by the channel setting cancellation information within a fixed time T2 (>T1) following the transmission of the channel setting cancellation information (YES in step S37), the channel selection table is updated so that the ONT 2b or 2c that transmitted the channel setting request becomes an ONT that is the object of monitoring with respect to the channel chx (step S38). Furthermore, the channel setting device 12 maintains the setting of the switch 11. As a result, the transmission of the distributed data of the channel chx is continued.

In a case where the channel setting device 12 of the OLT 1 receives channel setting requests according to step S36 from a plurality of ONTs (e.g., the ONTs 2b and 2c) at the same time, an ONT with a high priority is determined as an ONT that is the object of monitoring in accordance with an ONT priority ranking set beforehand in the channel setting device 12. For example, in a case where the priority ranking is set in the order of the ONTs 2a, 2b and 2c, the ONT 2b is designated as an ONT that is the object of monitoring.

On the other hand, if a channel setting request for the channel chx is not received within the fixed time T2 (NO in step S34), the channel setting device 12 interprets this as an indication that the channel chx has not been selected by either the ONT 2b or ONT 2c, and cancels the setting of the channel chx by the switch 11. As a result, the distributed data of the channel chx is not transmitted to the ONTs 2a through 2c from the OLT 1.

Following the cancellation of the setting of the switch 11 (step S40) (if the ONT 2a is not an ONT that is the object of monitoring with respect to the channel chx in step S34), or following the updating of the channel selection information (step S38), a notification of the completion of channel setting cancellation is transmitted to the ONT 2a (step S41).

After receiving the notification of completion of channel setting cancellation, the ATM multiplexer/,demultiplexer device 22 (control unit) of the ONT 2a stops the selection of the channel chx (step S41). Furthermore, the processing of stopping the channel selection in step S41 may be performed after the transmission of the channel setting cancellation request (step S32) and prior to the reception of the notification of completion of channel setting.

Furthermore, the channel setting processing and channel setting cancellation processing in the second embodiment was described using the ONT 2a as an example; however, the same processing is also performed by the ONTs 2b and 2c.

Thus, in the second embodiment as well, the distributed data of all of the channels ch1 through chn is not transmitted from the OLT 1 to the ONTs 2a through 2c; instead, only the distributed data of channels for which there has been a channel setting request (i.e., a reception request) is transmitted. Accordingly, the communication band between the OLT 1 and the ONTs 2a through 2c can be effectively utilized, and a large bandwidth can be allocated to the required distributed data, so that high-speed communications can be performed.

Third Embodiment

The third embodiment is an embodiment in which information indicating the selection status of channels is received from other ONTs when a certain ONT selects a new channel or stops the selection of a channel.

In the third embodiment as well, the overall construction of the PON network system, the construction of the OLT 1 and the construction of the ONTs 2a through 2c are the same as in the first embodiment; accordingly, a description of these parts is omitted here.

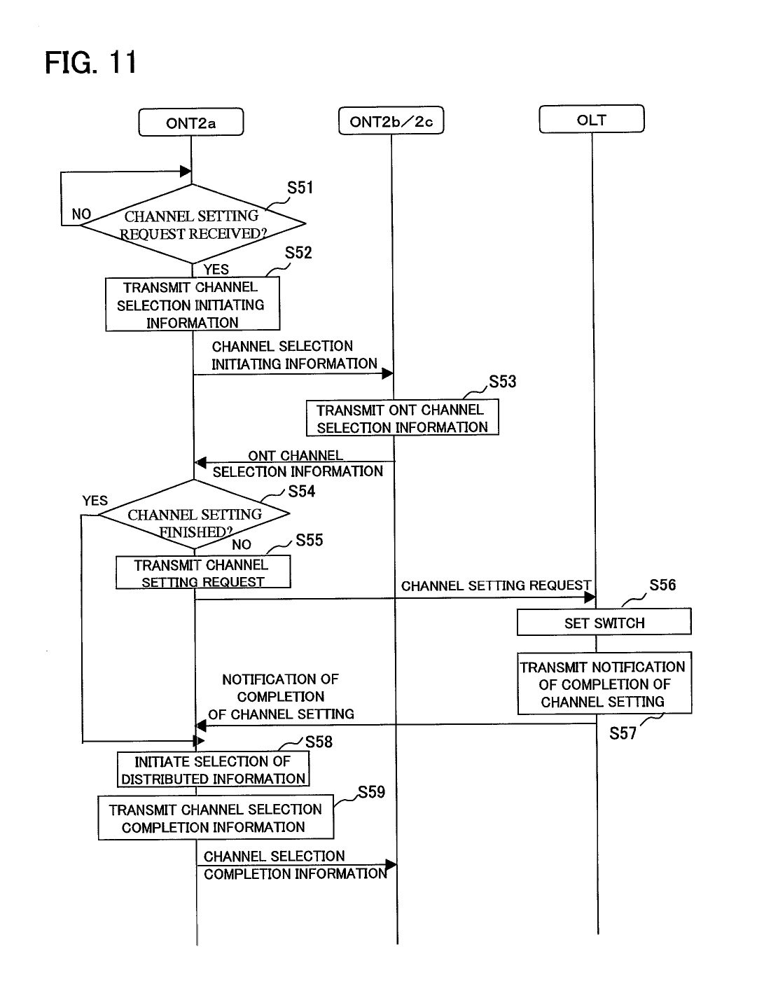

FIG. 11 is a sequence diagram showing the flow of the channel setting processing in the third embodiment. This flow will be described using a case in which channel setting is performed by the ONT 2a shown in FIG. 3 as an example.

When the multiplexer/demultiplexer device 22 of the ONT 2a receives a channel setting request for the channel chx from the user terminal A (B) via the user IF device 23 (24) (YES in step S51), the multiplexer/demultiplexer device 22 (control unit) of the ONT 2a transmits information (channel selection initiating information) that initiates the selection of the channel chx to the other ONTs 2b and 2c (step S52).

This channel selection initiating information contains information identifying the ONT 2a which is the transmission source, channel identifying information identifying the channel chx whose selection is being initiated, and information indicating the initiation of selection. This information is accommodated in the payload part of an ATM cell, and specified identifying information which causes the ONTs 2b and 2c to receive this channel selection initiating information is contained in the header part of the ATM cell. Furthermore, this channel selection initiating information may be transmitted via the optical fibers 4a through 4d and OLT 1 by means of the ATM cell that transmits control information, or may be transmitted via some other communication line (not shown in the figures) that differs from the optical fibers 4a through 4d.

When the ONTs other than the ONT 2a that is the transmission source of the channel selection initiating information, i.e., the ONTs 2b and 2c, receive the channel selection initiating information, the respective ATM multiplexer/demultiplexer devices 22 of the ONTs 2b and 2c transmit information for the channels that these ONTs themselves have selected (hereafter referred to as “ONT channel selection information”) to the ONT 2a that is the transmission source (step S53). This ONT channel selection information may also be transmitted via the optical fibers 4a through 4d and OLT 1, or via some other communication line (not shown in the figures).

When the ATM multiplexer/demultiplexer device 22 of the ONT 2a receives ONT channel selection information, the ATM multiplexer/demultiplexer device 22 judges whether or not the channel chx is included in the ONT channel selection information, i.e., whether or not the channel chx has already been set and selected by other ONTs (step S54).

In cases where the channel chx has already been selected by other ONTs (YES in step S54), the distributed data of the channel chx is also transmitted to the ONT 2a from the OLT 1. Accordingly, in this case, the ATM multiplexer/demultiplexer device 22 of the ONT 2a initiates the selection of the distributed data of the channel chx by altering its own setting (step S58).

On the other hand, if the channel chx has not been selected by the other ONTs 2b and 2c (i.e., if the channel chx is not included in the ONT channel selection information) (NO in step S54), the ATM multiplexer/demultiplexer device 22 of the ONT 2a transmits a channel setting request for the channel chx to the OLT 1 (step S55).

The channel setting device 12 of the OLT 1 sets the switch 11 in accordance with this channel setting request (step S56), and transmits a notification of the completion of channel setting to the ONT 2a (step S57). As a result, the distributed data of the channel chx is transmitted from the OLT 1 to the ONT 2a (and ONTs 2b and 2c).

After receiving a notification of the completion of channel setting from the OLT 1, the ATM multiplexer/demultiplexer device 22 of the ONT 2a initiates the selection of the distributed data of the channel chx (step S58). Afterward, the ATM multiplexer/demultiplexer device 22 of the ONT 2a transmits a notification of the completion of channel selection including identifying information for the channel chx to the other ONTs 2b and 2c (step S59). This notification of the completion of channel selection may also be transmitted via the optical fibers 4a through 4d and OLT 1, or via some other communication line (not shown in the figures).

Thus, in the third embodiment, the ONT 2a (2b, 2c) judges whether or not a channel setting request is to be transmitted, and transmits a channel setting request to the OLT 1 only when channel setting is required. Accordingly, there is no need for the OLT to judge whether or not channel setting such as a logical sum calculation or the like is to be performed, so that the processing burden on the OLT 1 is lightened. Moreover, since the ONT channel selection information is communicated between the ONTs, and not by the OLT 1, the processing burden on the OLT 1 is lightened even further.

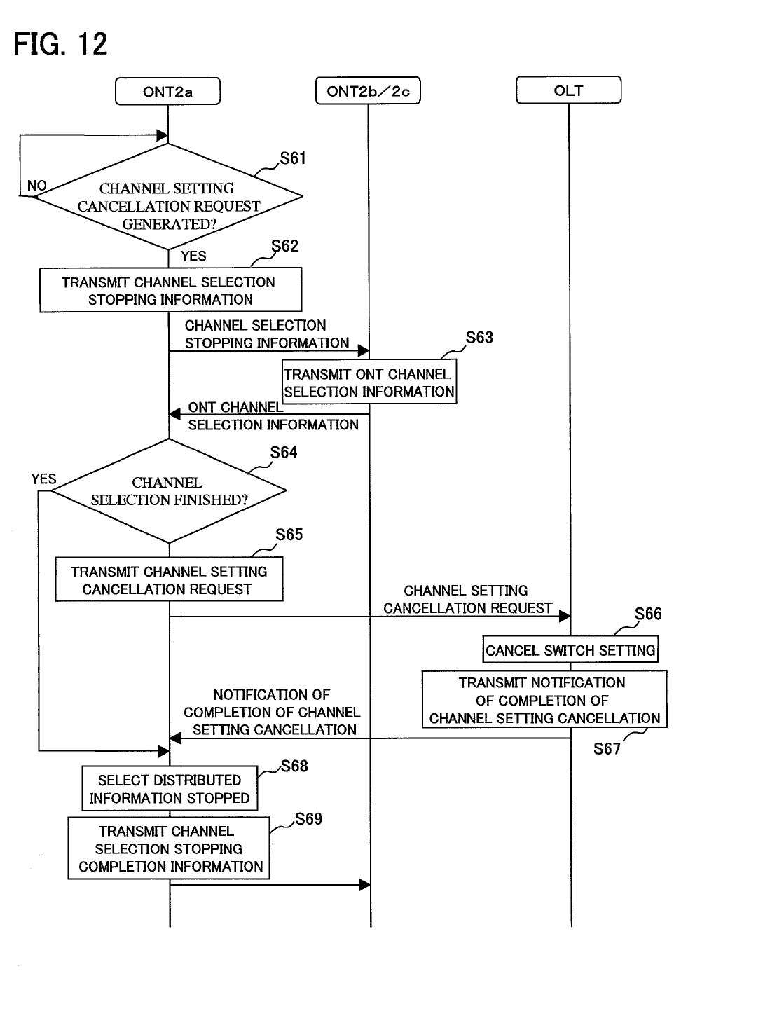

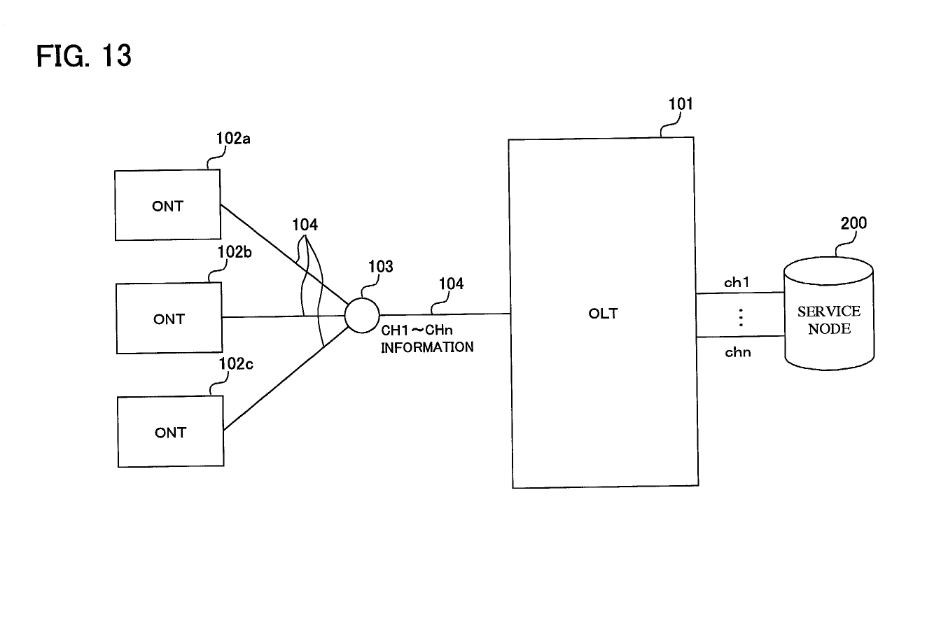

FIG. 12 is a sequence diagram showing the flow of the channel setting cancellation processing in the third embodiment. This flow will be described using a case in which channel setting cancellation is performed by the ONT 2a as an example.

When the ONT 2a receives a channel setting cancellation request for the channel chx from the user terminal A (B) (YES in step S61), the ATM multiplexer/demultiplexer device 22 of the ONT 2a transmits information (channel selection stopping information) which stops the channel chx and which is contained in the channel setting cancellation request to the other ONTs 2b and 2c (step S62).

When the other ONTs 2b and 2c receive this channel selection stopping information, the ATM multiplexer/demultiplexer devices 22 of these ONTs 2b and 2c respectively transmit the channel selection information of their own. ONTs to the ONT 2a (step S63).

On the basis of the ONT channel selection information transmitted from the other ONTs 2b and 2c, the ATM multiplexer/demultiplexer device 22 of the ONT 2a judges whether or not the channel chx has been selected by the other ONTs 2b and/or 2c (step S64).

If the channel chx has been selected by at least one of the other ONTs 2b or 2c (YES in step S64), the ATM multiplexer/demultiplexer device 22 of the ONT 2a cancels its own setting of the channel chx without transmitting a channel setting cancellation request to the OLT 1, and stops the selection of the distributed data of the channel chx (step S68).

On the other hand, if the channel chx has not been selected by both of the other ONTs 2b and 2c (NO in step S64), the ATM multiplexer/demultiplexer device 22 of the ONT 2a transmits a channel setting cancellation request for the channel chx to the OLT 1 (step S65). As a result, the channel setting device 12 of the OLT 1 cancels the setting of the channel chx by the switch 11. Consequently, the distributed data of the channel chx ceases to be transmitted from the OLT 1 to the ONTs 2a through 2c. Afterward, the channel setting device 12 sends a notification of the completion of channel setting cancellation of the channel chx to the ONT 2a (step S67).

After receiving the notification of completion of channel setting cancellation, the ATM multiplexer/demultiplexer device 22 of the ONT 2a stops the selection of the distributed data of the channel chx. After this selection is stopped, the ONT 2a transmits information indicating completion of the stopping of channel selection to the other ONTs 2b and 2c (step S69).

In regard to the process of channel setting and the process of channel setting cancellation in the third embodiment, the ONT 2a was described as an example; however, the same processing is also performed by the ONTs 2b and 2c.

Thus, in the third embodiment as well, not all of the distributed data of the channels ch1 through chn is transmitted from the OLT to the ONTs 2a through 2c; instead, only the distributed data of channels for which there has been a channel setting request (i.e., a reception request) is transmitted. Accordingly, the communication band between the OLT 1 and the ONTs 2a through 2c can be effectively utilized; furthermore, since a large bandwidth can be allocated to the required distributed data, high-speed communications can be performed.

In the present invention, the communication bandwidth between the optical line terminal and the optical network terminations can be effectively utilized. Furthermore, since a large communication bandwidth can be allocated to the distributed data for which there has been a reception request, the communication speed of the distributed data for which there has been a reception request can be increased.

What is claimed is:

1. A passive optical network system having an optical line terminal for transmitting a plurality of types of distributed data using optical signals, a plurality of optical network terminations for receiving said distributed data using optical signals; and a light splitting device for distributing the distributed data transmitted from said optical line terminal to said plurality of optical network terminations by means of optical signals,
wherein each of said plurality of optical network terminations comprises:
a control information transmitting unit for transmitting a reception request for at least one of said plurality of types of distributed data to said optical line terminal, said reception request designating the type of said at least one distributed data; and
a data selection unit for selecting distributed data for said reception request from one or more types of distributed data transmitted from said optical line terminal; and
wherein said optical line terminal comprises:
a distributed data transmitting unit for transmitting distributed data that is set to be transmitted among said plurality of types of distributed data to said plurality of optical network terminations; and
a setting unit for receiving said reception request and setting said distributed data transmitting unit so that distributed data of the types designated by said reception request is transmitted.

2. The passive optical network system according to claim 1, wherein said setting unit of said optical line terminal checks whether or not said distributed data transmitting unit has already been set to transmit distributed data of the types designated by said reception request, and sets said distributed data transmitting unit if said distributed data transmitting unit has not been so set.

3. The passive optical network system according to claim 1, wherein said control information transmitting unit of said optical network termination transmits a reception ending request for requesting ending of the reception of distributed data that is being received, to said optical line terminal, said reception ending request designating the type of distributed data for which the ending of said reception is requested; and
said setting unit of said optical line terminal receives said reception ending request, and cancels the setting of said distributed data transmitting unit for distributed data of the type designated by said reception ending request if distributed data of said designated type has not been selected by any optical network termination other than the optical network termination that has transmitted said reception ending request.

4. The passive optical network system according to claim 1, wherein said setting unit of said optical line terminal notifies the respective optical network terminations of type selection data for indicating the type of the distributed data that has been selected by each of said plurality of optical network terminations; and
said control information transmitting unit of said optical network termination transmits said reception request to said optical line terminal if the type of distributed data whose reception is requested is not included in said notification.

5. The passive optical network system according to claim 1,
wherein said control information transmitting unit of said optical network termination transmits a reception ending request for requesting ending of the reception of distributed data that is being received, to said optical line terminal, said reception ending request designating the type of distributed data for which the ending of said reception; and
wherein said setting unit of said optical line terminal notifies the other optical network terminations of the stopping of the transmission of the distributed data of the type designated by the reception ending request if the optical network termination that has transmitted said reception ending request is an optical network termination of a monitored object, said optical network termination of a monitored object being an optical network termination that has initially selected the distributed data of the type designated by said reception ending request in a state in which any of the optical network terminations has not previously selected said data;
cancels the setting of said distributed data transmitting unit for distributed data of said type if a reception request for distributed data of said type is not received from the other optical network terminations within a specified time following said notification; and
maintains the setting of said data transmitting unit for distributed data of said type, and designates the optical network termination that has transmitted said reception request as a new optical network termination of the monitored object, if said reception request is received within said specified time.

6. The passive optical network system according to claim 5, wherein, when two or more said reception requests are simultaneously received from two or more optical network terminations within said specified time, said setting unit of said optical line terminal designates an optical network termination with a high priority according to a preset priority ranking as a new optical network termination of the monitored object.

7. The passive optical network system according to claim 1, wherein said control information transmitting unit of said optical network termination notifies other optical network terminations of the type of distributed data whose reception is requested, transmits said reception request if said type of distributed data whose reception is requested is not present among the types of data transmitted from other optical network terminations, which is being received by said other optical network terminations, and, if said notification is received from another optical network termination, transmits the type of distributed data being received by said optical network termination itself to said other optical network terminations.

8. A communication method in a passive optical network system having an optical line terminal for transmitting a plurality of types of distributed data using optical signals, a plurality of optical network terminations for receiving distributed data using optical signals, and a light splitting device for distributing the distributed data transmitted from said optical line terminal to said plurality of optical network terminations by means of optical signals, said method comprising steps of:
transmitting, in each of said plurality of optical network terminations, a reception request for at least one of said plurality types of distributed data to said optical line terminal while designating the type of said at least one distributed data; and
transmitting, in said optical line terminal, distributed data of the type designated by said reception request transmitted from each of said plurality of optical network terminations among said plurality of types of distributed data to said plurality of optical network terminations.

9. An optical line terminal in a passive optical network system, for distributing distributed data to a plurality of optical network terminations by means of optical signals, comprising:
a distributed data transmitting unit for transmitting distributed data that is set to be transmitted among a plurality of types of distributed data, to said plurality of optical network terminations; and
a setting unit for receiving a reception request transmitted by at least one of said plurality of optical network terminations, said reception request designating the type of distributed data whose reception is requested among said plurality of types of distributed data, and for setting said distributed data transmitting unit so that distributed data of the types designated by said reception requests is transmitted.

10. A communication method performed by an optical line terminal for distributing a plurality of types of distributed data to a plurality of optical network terminations by means of optical signals via a light splitting device, comprising steps of:
receiving a reception request transmitted by at least one of said plurality of optical network terminations, said reception request designating the type of distributed data whose reception is requested among said plurality of types of distributed data; and
transmitting distributed data of the type designated by said reception request among said plurality of types of distributed data.

11. An optical network termination in a passive optical network, for receiving distributed data transmitted from an optical line terminal by means of optical signals, comprising:
a control information transmitting unit for transmitting to said optical line terminal a reception request for setting said optical line terminal so that said optical line terminal selects and transmits distributed data whose reception is requested by said optical network termination among a plurality of types of distributed data, said reception request designating the type of said distributed data whose reception is requested; and
a data selection unit for selecting and receiving distributed data for said reception request from one or more types of distributed data transmitted from said optical line terminal among said plurality of types of distributed data.

12. A communication method performed by an optical network termination in a passive optical network system, said optical network termination receiving distributed data transmitted from an optical line terminal by means of optical signals, said method comprising steps of:
transmitting to said optical line terminal a reception request for setting said optical line terminal so that said optical line terminal selects and transmits distributed data whose reception is requested by said optical network termination among a plurality of types of distributed data, said reception request designating of the type of said distributed data whose reception is requested, and
selecting and receiving distributed data for said reception request from one or more types of distributed data transmitted from said optical line terminal among said plurality of types of distributed data.
